(19) United States
(12) Patent Application Publication
(10) Pub. No.: US 2015/0248483 A1
(43) Pub. Date: Sep. 3, 2015

(54) Managed Social Media Publicity Business Network for Business Personnel

(71) Applicant: Jeffrey Glen Bonnell, Scotch Plains, NJ (US)

(72) Inventor: Jeffrey Glen Bonnell, Scotch Plains, NJ (US)

(21) Appl. No.: 14/536,657

(22) Filed: Nov. 9, 2014

Related U.S. Application Data
(60) Provisional application No. 61/902,873, filed on Nov. 12, 2013.

(51) Int. Cl. G06F 17/30

(52) U.S. Cl. CPC G06F 17/30864; G06F 17/30882; G06F 17/30781; G06F 17/30047; G06Q 50/01

(57) ABSTRACT

The invention is a method, system, and software for creating a managed online publicity venue for multiple business personnel in a social networking environment which works in conjunction with their centralized business online marketing materials and also exists independently as free standing, person-by-person online marketing materials.

### CROSS-REFERENCES TO RELATED APPLICATIONS

Not Applicable

### STATEMENT REGARDING FEDERALLY SPONSORED RESEARCH FOR DEVELOPMENT

Not Applicable

### MICROFICHE APPENDIX

Not Applicable

### BACKGROUND OF INVENTION

The main challenge for businesses which compete with others and offer identical goods and services, and which are controlled either by regulation, or by franchise rule, is that it becomes difficult for consumers to differentiate between competing businesses because of the lack of differences in the facilities, service and product/price offerings. A potential patron of such a business has little information or knowledge of differentiating qualities with which to make a qualitative decision about whether or not to choose any particular business over another in a one-to-one, or one-to-many competitive environment.

Today, even if a prospective customer visits multiple websites representing local businesses which offer the same products and/or services, there only remains the professional and personal human quality of the individuals who work at, and represent, such businesses.

Modern social media networks have appeared, evolved, and have a large presence on the Internet where people share content, and knowledge about one another in an editorially unencumbered and freewheeling way. While this has enabled the true personal nature of people to be revealed in the writings, materials, postings, photographs, videos and related materials that they place on these networks in both public and semi-private access for others to see, this has left businesses with a less than perfect venue with which to present the personal and professional, yet still social and fun nature of the individual humans who work for them. A business which desires to influence potential customers with the good nature, knowledge, and integrity of their employees as they seek to encourage customers to communicate further in the purchase process, and give the business a competitive advantage, having leveraged the positive aspects of their employees, needs to maintain an editorially controlled public presence of socially published content and information.

The mainstream personal social media platforms that exist for persons to participate in on a voluntary basis are not normally within the confines of their employers' control, and therefore, not subject to professional constraints in terms of content and opinion. Therefore mainstream personal social venues themselves do not make appropriate platforms for business participation when promoting the positive qualities of their employees on an individual basis.

Additionally, many franchised based businesses are under increasing parent organization controls, yet they still operate in a very competitive environment individually. These businesses still must look to leverage themselves positively as much as possible to compete and thrive, and therefore must look to leveraging their people, and their goodness, as a publicity asset in a business-managed social content environment.

Also, businesses today have an express need to protect the outcome of search engine results which are generated by search engines such as Google, Yahoo, Bing and many others when prospective customers search using the name, or a variation thereof, of their businesses.

Therefore it is important to devise legitimate content and online materials which are representative of the business, which serve to aid in the search engine results. Various types of undesirable results such as; competing businesses, businesses which gather and resell sales leads, poor reviews, and uncontrolled content are preferred by any given business to be moved to subordinate positions in a search result for that business by utilizing legitimate and well-formed content and websites which are actually representative, and positive for and of the business.

1. Field of Invention

This invention relates to the field of data processing, specifically to business practice, management and customer communication for product and service information. In particular for consulting and personnel selection for customer interaction utilizing the internet and publically available networks to display multi-media presentation materials which communicate the personal, and professional, historical, and present day personal and professional information body relating to an individual and individuals who comprise the customer interaction teams at a place of business displayed within an online, managed social network.

2. Description of Related Art

As of this application's date it is commonplace for a business to maintain one or more bodies of information about itself on the internet in the form of a website, or internet-based content and materials which present it's products and services, and extend further into background and forward thinking information about itself, so that customers and potential customers may make informed decisions concerning doing business and conducting business transactions with such organizations. Typically a portion of such online marketing materials are dedicated to a presentation of information as it relates to the person, persons or personnel with which a customer would interact with in the conduct of such business. Almost universally, businesses neglect that portion of their online marketing materials as it relates to their own personnel, and professional information available about their personnel. The depth of such information is usually universally lacking. When it is present, it is usually lacking in substance and is generally based in text, which tests poorly in reader attention. Additionally there is no evidence of including the technical steps for dynamic content management or independent social website platforms which turn the human factor at a business into social marketing assets online which can be leveraged for search engine optimization.

### BRIEF SUMMARY OF THE PRESENT INVENTION

The present invention comprises a service component (a), a website component (b), a content management component (c), a multi-media technology component (d), a search engine optimization component (e), an evaluation component (f), and a human resources component which (g), when taken together, comprise a Managed Social Media Publicity System.

The service component is the provision of the project coordination, technical, individual website setup, domain name nomenclature determination, composition and software coding to create hypertext back links which connect the managed social websites to the business's own main website, the conduct of the interview process with the individuals who are participating in the program, the gathering of the and processing for size and optimization of photographic materials, the creation of video-based materials such as vehicle descriptions or introductions, the processing and integration of customer-provided video materials, the conduct of an interview process which serves to gather material data about each person who is a participant in the program, copywriting to create a verbose description of the person, and various additional activities as necessary to assemble the information for the content of the social media sites provided for each individual participant in the program. Additionally, training is provided for each person so that they are given an understanding of the use of the interactive content management aspect of the system so that they can modify the online materials which make up the site which features them, and the importance of their participation and cross promotion into their other online social venues.

The website component is a series of small websites, each of which is developed and deployed for each individual person participating in the program. A website is created and deployed for each person that the business wishes to promote to the potential customers of the business. While the website for each person exists as pages of web content which are installed within the existing main website which the business utilizes, each website for each person also exists as an independent, free standing website for each person. It is hosted independently and has its own top level domain, such as www.bob-smith-biz-name.com.

The content management module provided for each person has an administrative panel to which they can securely login in. Once there, they can add, delete, or modify content (text, pictures, videos, details) in a variety of ways.

The multi-media technology component, provides the capability for the latest available multi-media technology to be utilized, such as real time SMS texting, web page to streaming Smartphone video and computer generated text-to-speech capabilities to dress up the interaction and entertainment value of the personal presentation.

The search engine optimization component provides the website navigational menus which link the free-standing personnel-based website back to deep web pages within the businesses (such as a car dealerships) website. This helps provide additional coverage and presence which search engines may find valuable and help those businesses expand the number of and quality of linked results which appear from certain searches made in certain search engines. Additionally the content which is engineered into the individual sites is arranged to benefit to core, or base business website and increase its online prominence.

The evaluation component provides a service to the participating business so that internet traffic (ie. Potential customers) is measured, which evaluates the number of potential customers who find the individual managed social media sites which are deployed for individual personnel. As visitors to those personnel websites move from those sites to the core business websites the traffic is measured in aggregate over time periods to gauge the effectiveness of the program. Additionally, services are provided prior to the program to measure average visitation to the business website and average conversion, that is the percentage of visitors which visit and actually act moving from a position of anonymity to a position of having divulged their identity to the business and invited the business to interact with the potential customer in a potential business transaction.

### DETAILED DESCRIPTION OF THE INVENTION

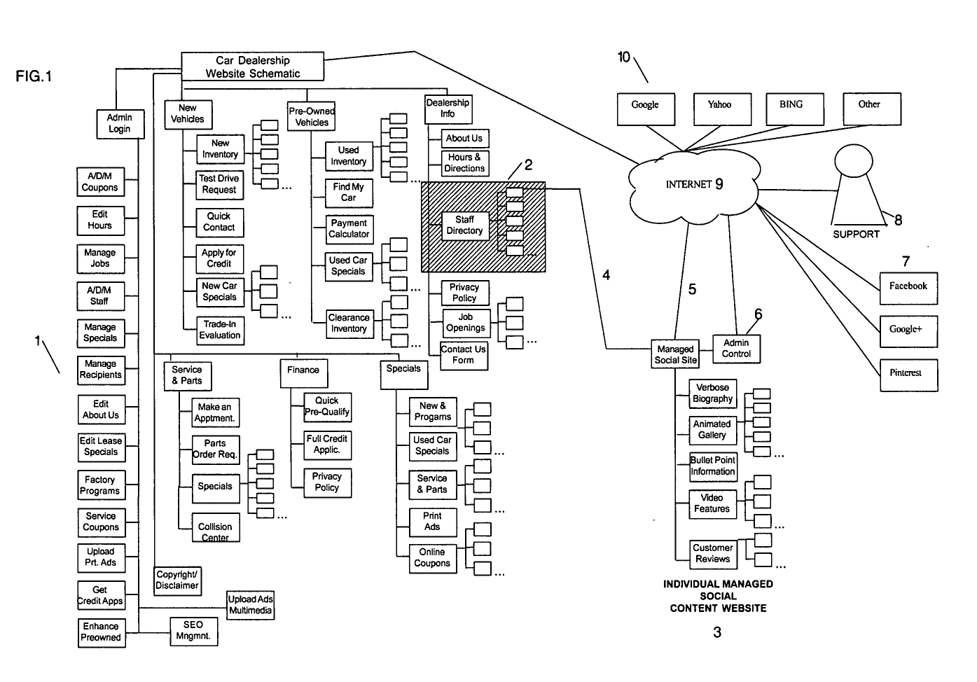

FIG. 1 shows a schematic representation of the pages of content and relationship between them which make up the elements of information and data for a website belonging to an automobile dealership, typical of the business type and classification that would find this invention process useful in its business operation. For illustrative purposes this business website schematic shows most areas of content, merchandising and factual information areas such a business may present in it's online information array (1) The cross-hatched Box (2) shows the area of the website depicting the Staff Directory.

Central to the operation and function of the process is this invention is the Staff Directory of the business's website. As the business seeks to promote the business and encourage potential new customers to internalize positive thoughts regarding their business, the business uses this invention and it's business process to present and manage materials, content and information about the people that work at the business and provide customer service and interaction with customers at the business. Typically these would include Sales, Service and Management personnel.

As a point of reference Internet (9) represents the interconnect web of communicating digital devices through which advertising and information materials for the business are access by any other computer via the public internet(s) for consumer use.

(2) Shows the Staff Directory of this business site and page content that lies within the business website as pages within the domain of that website. In this embodiment and invention the content and information of the invention and information about the individuals exists as pages within the businesses' website(s) and so appear as to be pages of content and information inside the businesses domain.

This represents one facet and use of the comprehensive information and multimedia presentation materials as our process makes available on each person so that the information is available to visitors to the businesses website. They are, as they appear—pages within the business website which present social content which is managed by an editorial and publicity staff at our service business. This represents presentation facet Number One within our invention's process.

(3) Shows a representation of the construction of the content and multimedia presentations about any given individual person who is participating in the program as those materials are deployed as part of the program whereby the materials are deployed as a stand-alone website of their own accord and exist dually on the Internet on their own as a free standing website about each person. By being technically deployed as independent websites for each person, and comprising multiple pages of content in a variety of media forms, having text, photographic, audio, and video content and well as means of interacting with the persons about whom the invention websites are deployed and managed via telephone, SMS/Text, Email and real-time video link the individual sites deployed for each person serve an essential promotional function within the scope of the objective of this design and method of promoting the stature of the business within its exposure in search engine placements of search results and in giving the participating employees exposure and publicity results when potential customers use search engines to place queries designed to find them by name, or to find the business by name, location, location and product, name and business name and other combination of search criteria which are deemed to be important and be objectives within the scope of the deployment of the process.

Within the realm of the setup of these individual websites the entire process, by deploying a series of websites for a given business utilizing the employee population at hand, the process deploys a series, or family of additional small websites which creates a network of relevant content which build on the businesses search engine results exposure grid. While the nature of the content aids in this result, the addition of careful domain name strategy for each of the individual people websites also serves to enhance the process. As well, a navigational schema which links back to the businesses website using a network of deep links into the businesses website are used in each, and all, or the small human feature websites. This serves to further aid and enhance the business website.

Cosmetically the human-based individual websites are built to match the aesthetics of the parent business site and bolster, rather than hinder its online stature.

From a technical publishing perspective administrative controls are built into the process to make frequent change and addition management of each person's content to be easy to accomplish. The content is also designed to focus on ease of user absorption and relies on imagery, headlines, and multi-media. In this manner potential consumers have been found to be most highly influenced. The invention process includes automated alerts which provides for drawing service personnel into a work checking, or change checking process so that changes can be monitored on an ongoing basis and spelling, grammatical and cosmetic adjustments can be added.

Administrative Control (6) provides the user and/or the Administrator with the ability to add, delete or modify content across the range of areas within the individual's social content website and provides for the expansion of content for further search engine material and updates with which to influence visitors with in accordance with good and preferred website editorial practices. These content changes can be made by the owner of the website at the business, an administrative assignee at the business, and editorial administrator provided as part of the service provision by the inventor and can be accessed from any web browser software which can access the internet.

In the initial setup process, within the overall marketing strategy, as exercised by the inventor in and the process, is comprised of an interview process which takes place and gathers the editorial content and material needed for the assembly of, and professional review and creation of, the story and material which will be presented about any given person. On an individual basis these materials serve to present a picture of the person to a potential customer and paint a multi-media picture as to who the employee is, and how they provide an advantage to the potential customer for doing business with the business because of the personal, professional, training, experience and nature of the person and persons who work at the given business. When taken individually, these little websites promote the good human nature of the individuals while serving to aid each individual in their professional prowess at the given business. When taken collectively they serve to buttress the professional prowess and stature of the entire business in question which is deploying the assortment of, and family of, human feature managed social websites that this invention and process provides.

There is an opportunity with these websites to periodically announce and make them known in the truly personal mainstream social online venues such as Facebook such materials as may be available, and made known to potential customers there cross-promoting to the purely personal and social contacts in any given individual's social contact network in private networks (ie Facebook, Instagram, Pinterest, Etc.). When taken collectively, these efforts to cross-promote information and material serve to interject information about a place of work and business into a purely social online venue in a less commercial and therefore potentially less harmful way (7).

Businesses today rely on metrics or measurements taken from their website visitation with give them benchmarks, goals and attainments across various key factors which tell them about the effectiveness of the efforts and their effect on promoting business prosperity. Within the scope of this method and process is a facility for gathering benchmark information about visitation levels to the businesses core or main website(s) and the numbers of customer contact opportunities that result from such traffic as it typically exists prior to embarking on a program and process described herein. Once the benchmarks are established such as a typical “conversion ratio” such as the number of customer phone calls as measured versus the number of unique visitors or total page views or some other consistent basis of measurement, then a response mechanism is included here in the process so that a before and after measurement and an ongoing tracking can be obtained and evaluated, both in terms of changes in the numbers of potential business opportunities or customers that visit the business website, and also the ration of conversions. The objective of the process and invention to have a positive effect and influence on the ration of conversion—a positive influence on the number of visitors who are convinced because of the presentation of managed social information that the information presented about the people who make up the populace of the business employees make a better and more convincing argument that they should be the business of choice for that consumer and the consumer makes the choice to contact the business and allow themselves to become potential customers.

As a feature of the process the handling of any employee turnover within the publicity service are handled by technically forwarding any website for individuals who have left the employ of the business into loading the homepage of that businesses website's staff directory.

Within our inventions process on evolving technical features meant to keep abreast of technical and digital accessories as they exist in the marketplace and as are typically in use by both the public and the personnel at the given business. Some examples of such integration as they exist at the time of this filing include the integration of Smartphone technology that includes the ability of potential customers to send SMS/Text messages directly to the “Smart-phones” of employees in order to communicate in real time directly to them. We also have integrated, and will continue to integrate applications as they become available such as real-time streaming video such as Skype and Ustream so that a face-to-face streaming video conversation can be conducted with customers.

We understand that our process has benefits to the business and individuals who participate that include intangible benefits to the business individuals in the portion of the business and of the individuals which are not measureable in a finite scale, but still merit mention in the scheme and scope of the method at hand. The presence of the managed social sites themselves as they stand alone in Google and other major search engines makes those individuals find-able when search and queries are conducted for them in those search engines. This provides them with a certain stature and renown which is a positive thing, not only in the eyes of their potential customers but also in the eyes of their friends, and family. This provides the business owner with a human resources benefit which helps that business as an employers provide a more prestigious place of employments. At the same time. When an employer makes an investment in underwriting online materials for individual employees which help them look good in the eyes of potential customers and when those employees benefit from have additional customers, that helps to make that business a better workplace. So this process and invention brings the added benefit of enhances the workplaces for the employer.

### BRIEF DESCRIPTION OF DRAWINGS

(FIG. 1) Schematic of the Existing (non-invention) Business Website (1) including it's original Personnel Directory (2) showing the hyperlinked integration of internalized Invention (3) shown in an individual internet website. Example hyperlinked from a single person's Staff Listing (4) to an independently existing stand-alone website of the invention (3). Related components relating to social venue content exposure (7), customer support administration (content moderation) (8), and public search engine exposure (10) are depicted.

Having described my invention, I claim:

1. A business process for creating a network of content based websites of business managed social information about employees of the business which are placed on the internet and in the company's website to create a positive influence on the decisions of potential customers.

2. A process of providing consultation, content gathering for prose and multi-media content about multiple business employees. Copywriting and internet social publicity creation by personnel for the creation of managed website social content and social content independent websites which promote personal employee information for the benefit of the business.

3. A method of coordinating the website navigation and hypertext links which relate back to the main website of the business using this invention and business process which placees such links in the independent managed social website and helps increase the exposure of the businesses'

4. main website, stature, quantity and quality of exposure of organic search engine results when persons make searches on the businesses' name or related searches.

5. A website process of content management which controls access to administrative content controls for adding, deleting or modifying materials in each individual personal social website which allows for real time change by the individuals, administrative personnel at the place of business, outside consultants or other personnel as assigned to such content management tasks, and a feature in the process by which such individuals who are charged with maintaining standards for content material, spelling, grammar and language are alerted and drawn into a checking procedure for any content changes brought into the process by any of the authorized individuals.

6. A means within the managed social personnel website for individuals to interact and communicate with individuals via email, SMS/Text messaging to cell phones, pages, smart phones and related devices and a means by with to connect and create a real time video connection with connects the personnel website page with a streaming video link at the subject personnel smart phone using an inherent embedded application of post loaded application form a third party.

7. One or more means of providing photographic visual slide shows and presentation of photographic materials in the managed social content personnel website to give the visitor and potential customer a strong visual presentation on the nature and substance of the subject person without making it necessary to read text-based materials.

8. A means of providing an editable, verbose text-based biography which is unlimited in length and may be edited and changed in real time as desired. This portion of the content provides the facility for the subject person to provide prose about themselves and their ideas, philosophies, opinions and background as they relate to their professional and personal

9. endeavors as they may influence potential customers in a positive light and influence their decision to contact said personnel.

10. A means of completing an online content generating questionnaire which automatically creates a bullet-point list of biographical and professional highlights about the subject personnel within the context of the managed social personnel website which gives the potential customer and reader of the site a quick read of bullet-pointed highlights of the person's qualifications and details so as to influence the reader in a positive light.

11. A consultative process and service within the scope of the invention process to regularly schedule and review the content in managed social personnel website which are deployed for a business to maintain the fresh nature of the content and create a positive influence in the indexing activity of the search engines which read and index the content within them.

12. A facility to include a content publishing application for the publication of multiple customer testimonials for a given individual who is participating in the program. In this manner multiple customers who have had prior experiences with an individual can express their views and the content management administrators involved in these managed social content websites can add opinion based content of prior customers to the influence of potential customers.

13. A means of incorporating embedded internet videos of the person who is featured in the managed social personnel website. Multiple internet videos may be inserted directly, or may be embedded from major third party video venues such as YouTube. These videos provide a convenient sight, sound and motion presentation and show potential customers the actual human being featured in the website. Any appropriate video as deemed by the business managed social content team would be enabled which might include product demonstrations general introductions, family vignettes, sports highlights, awards ceremonies, accolades, or other appropriate video presentations.

14. A mechanism of setting benchmark statistics in terms of major search engine exposure footprint result on baseline organic search in major search engines using before and after A/B studies prior to and after the program at one month intervals and benchmark analysis of unique visitor tallies to the business websites and sectionals of the business website and A/B before and after studies at monthly interval or other intervals as deemed useful to measure changes in the effectiveness of the program in creating additional customer contact opportunities for the business as measured against traditional results.

15. An interview process after the program of managed social media websites for personnel has been in place to measure the intangible benefits to personnel of having shown up in search engine results and appearing in their own website promoting themselves and the business.

16. A consultative process whereby the business in the program is given the information and resources they need to incorporate the benefit of personnel promotion in managed social media online venues as a benefit of employment at the business and parameters with which to conduct the deployment of such websites for personnel to maximize the efficiency of the investment made in the program.
